(19) United States
(12) Patent Application Publication
(10) Pub. No.: US 2010/0312154 A1
(43) Pub. Date: Dec. 9, 2010

(54) VIBRATION APPARATUS WITH REAR MOTION INDUCER AND FRICTIONLESS COUPLING AND METHODS FOR COMPENSATING LOAD AND CONTROLLING WAVEFORMS

(76) Inventors: Carl Marthinus Becker, Westville (ZA); Andrew Mark Hewitson, Dana Point, CA (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 12/739,629

(22) PCT Filed: Oct. 22, 2008
(86) PCT No.: PCT/ZA08/00099

§ 371 Date: Aug. 13, 2010

Related U.S. Application Data
(60) Provisional application No. 60/981,943, filed on Oct. 23, 2007.
(60) Provisional application No. 60/981,957, filed on Oct. 23, 2007.
(60) Provisional application No. 60/981,979, filed on Oct. 23, 2007.

(51) Int. Cl. A61H 1/00

(52) U.S. Cl. 601/49

(57) ABSTRACT

A whole body vibration apparatus 100 with the motion inducing device 110 positioned other than under the vibrating platform 194 so that the vibrating platform 194 may be located close to the ground. Dual rocker shafts 178 journalled to reciprocate in a rotationally reciprocating motion, convert the linear motion of the rear-positioned motion inducing device 110 to vertical motion of the vibrating platform 194. A coupling mechanism constituted by a linkage 172, 174, 178 connects the motion inducing device 110 to the vibrating platform 194. The linkage employs deformable couplings 172, 174 and frictionless bearings to reduce unwanted rattle and wear and to remove the need for maintenance. A compensating device 140 adjusts for the weight of the user so that the motion inducing device 110 has all its useful output employed to vibrate the platform 194 as opposed to supporting the user's weight. In addition to altering frequency and amplitude, a method for user selection of different waveforms is provided to achieve a variety of treatment benefits.

### FIELD OF THE INVENTION

The field of the invention is vibration devices for physiologically stimulating a living organism.

### BACKGROUND

It has long been recognized that vibrational therapy and/or exercise is beneficial to the human body. For example, numerous publications and patents disclose various methods and/or vibration devices for exercise, speed and endurance training, promoting bone growth, therapeutically treating bone fractures, osteoporosis, other tissue conditions, postural instability, and other conditions such as cystic fibrosis, Parkinson's disease, arthritis, and multiple sclerosis.

Typically, such vibrational devices include a base frame with a rigid platform configured to support a user, and a vibration inducing mechanism coupled to the platform, such as those disclosed in U.S. Pat. No. 5,376,065 to McLeod (December 1994), U.S. Pat. No. 6,234,975 to McLeod (May 2001), U.S. Pat. No. 6,843,776 to Trandafir (January 2005), U.S. Pat. App. Pub. No. 20060217640 to Trandafir (September 2006), U.S. Pat. No. 7,141,029 to Kim (November 2006), and U.S. Pat. No. 7,207,955 to Krompasick (April 2007). These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

As a result of the vibration inducing mechanisms of McLeod, Trandafir, Kim, and Krompasick being disposed within the base and underneath the platform, the bases of such devices have a relatively great thickness, (e.g. 25.4 cm (10 inches) or more), which limits the range of use and ease of use due to the height of the platform from the ground (e.g., wheelchair access, seniors).

There are low profile vibration devices. U.S. Pat. App. No. 20060241528 to Talish (October 2006), for example, still places its motor under the platform, but achieves a low profile design by levitating and vibrating the platform using opposing magnets. Such devices, however, are uneconomical, and limited in efficacy and/or range of use due to their small size.

U.S. Pat. No. 6,620,117 to Johnson (September 2003) achieves a low profile design by positioning the motion inducing device externally to the base of the platform. However, Johnson uses rotational motors with a cam arrangement for producing both horizontal and vertical vibrations. Such cam-style linkages cause the vibrating platform to follow a fixed path dictated by the mechanics, thus causing the platform to move as designed irrespective of changes to the platform load. As a result the user is subjected to a relatively rough ride that is uncomfortable and places undesirable shock loads on the joints of the user. Furthermore, Johnson's apparatus has a maximum amplitude of vibration of 2.0 mm, when the required amplitude of vibration for effective therapy at lower frequencies (less than 6 Hz) is more than 5.0 mm.

Thus, there is still a need for a vibration apparatus with a side or rear positioned motion inducing device.

Another significant problem with the known vibration platforms is that they do not adequately compensate for the weight of the user. The Trandafir, Kim, and McLeod devices all adjust the amplitude and/or frequency of the oscillatory driving wave to compensate for the user's weight. While this approach has some efficacy for vibration platforms that employ rotational motors as the motion inducing device, this approach has limited effect when used with vibration platforms that employ linear motors (Kim) as the motion inducing device.

Thus, there is still a need for a method of driving a platform vibration apparatus having (a) an electromagnetic motion inducing device and (b) a device that at least partially compensates for different loads disposed upon the vibration platform, thus providing a more efficient and effective vibration device.

There are vibration devices that use sinusoidal signal generators, such as those disclosed in U.S. Pat. App. Pub. No. 20060217640 to Trandafir (September 2006), and WO 2006001656 to Kim (January 2006).

Hobson (US 20060106313) discloses associating particular platform movements with particular disease conditions. However, the platform movements in Hobson are accomplished by adjusting the frequency and/or amplitude of the oscillatory force in both the X and Y axes.

Thus, there is still a need for a method of operating a vibration device that includes operator controlled software for altering the waveform of a vertical component of motion of the device, other than merely the amplitude and frequency of the oscillatory force, to achieve different treatments effects.

Johnson (U.S. Pat. No. 6,620,117), Trandafir (US App. 20060217640), U.S. Pat. No. 20070225622 A1 to Huang (September 2007) and Kim (U.S. Pat. No. 7,141,029) describe mechanisms that couple the motion inducing device to the vibrating platform. The reciprocating motion of the vibrating platform causes static friction break-away and backlash in these coupling mechanisms. Static friction in bearings causes the bearing to bind until the applied force overcomes the static friction between the two parts of the bearing. This break-away effect results in an undesirable knock and residual vibration at each change of direction in the reciprocating motion. Backlash is the property of a bearing, hinge or other coupling mechanism caused by the play or tolerance between the bearing surfaces, where with each change of direction, one part of the bearing, hinge or coupling mechanism travels momentarily free before it strikes the opposite bearing surface. Backlash is an unavoidable and undesirable property of such mechanisms when used to couple reciprocating motion. These effects in a whole body vibration device result in undesirable and unintended noise, residual vibration passing to the user, and wear and tear of the device.

Thus, there is still a need for a method of coupling the motion inducing device to the reciprocating vibrating platform such that the coupling mechanism eliminates the effects of backlash and static friction.

### SUMMARY OF THE INVENTION

The present invention provides apparatus, systems and methods for a vibration apparatus with a moving platform, having (a) a platform sized and dimensioned for a person to stand, sit or lie upon; (b) a first motion inducer positioned other than under the platform; and a linkage that transfers a force from the first motion inducer to the platform, such that at least a first portion of the platform moves in a substantially vertical motion; (c) a controller for utilizing operator controlled software for altering the waveform of a vertical component of motion of the platform, other than merely the amplitude and frequency of the oscillatory force, to achieve different treatments effects; and (d) a device that at least partially compensates for differences in a load disposed upon the vibrating platform.

### BRIEF DESCRIPTION OF THE DRAWINGS

The invention will be further described with reference to the accompanying drawings in which:

FIG. 1 is a diagrammatic cross sectional side elevation of the vibration device;

FIG. 2 is a diagrammatic cross sectional end elevation of the vibration device illustrating the coupling mechanism that transfers movement from the motion inducer to at least one part of the vibrating platform; and

FIG. 3 is a block diagram illustrating the steps of a method of driving a vibration platform device according to the invention.

### DESCRIPTION OF EMBODIMENTS OF THE INVENTION

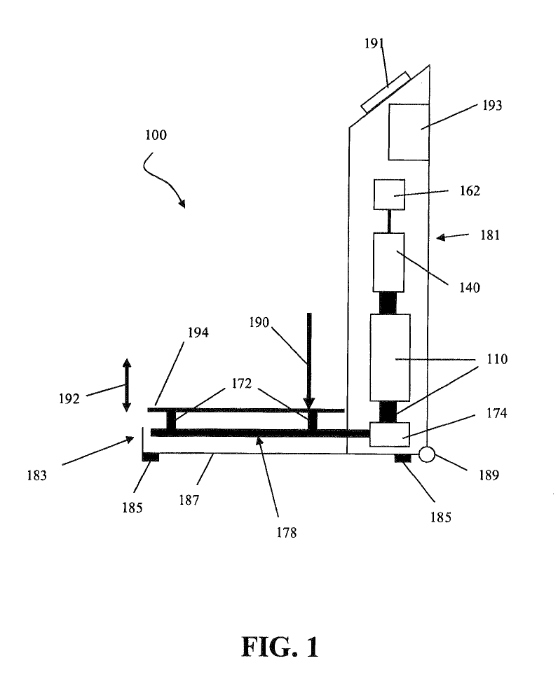

FIG. 1 is a cross sectional view of the vibration device 100 which generally includes two housings constituted by a tower 181 and a base 183. Preferably, vibration device 100 can be constructed out of a combination of metals, metal alloys, high impact plastics, and any reasonable combination thereof, in order to realize low residual vibration and minimal metal fatigue.

Base 183 is depicted generally as having a base frame 187, support feet 185, at least one of which is height adjustable, dolly wheels 189 to facilitate movement of the device, and vibrating platform 194.

Preferred vibrating platform 194 can be sized and dimensioned for a person to stand on, such that vibrating platform 194 has an upper surface area measuring at least 1 m². In an alternate embodiment for exercise such as Pilates and Yoga platform 194 can have an upper surface area measuring at least 2 m². Platform 194 preferably has a square or rectangular shape, but other suitable shapes are contemplated. Platform 194 also can be capable of supporting at least 200 kg, and can incorporate a non-slip mat or coating (not shown) with a profile that can stimulate the acupressure points in the sole of the foot.

In most preferred embodiments platform 194 has a front and a rear, and motion inducer 110 is oriented vertically to the rear of platform 194. Advantageously, base 183 can have a height of anything between 5 cm and 15 cm as a result of the motion inducer 110 being oriented vertically to the rear of the platform in contrast to being disposed underneath the platform.

Tower 181 is depicted generally as having an electronic display 191, control electronics 193, motion inducer 110, deformable coupling 174 which attaches motion inducer 110 to rocker shaft 178, and compensating device 140 that compensates for the weight of different users. Advantageously, the linkage that transmits motive force between the motion inducer 110 and the platform 194 includes no more than four moving parts, including the motion inducer and the vibration platform 194 and uses fixed deformable couplings to link moving parts instead of bearing-based couplers which exhibit backlash, friction and wear.

Device 140 at least partially compensates for different working loads 190 applied to platform 194, such that the force generated by motion inducer 110 is not used to support the weight of the user, and can therefore be more efficiently recruited to induce motion on the platform. Preferably compensating device 140 is comprised of either a linear actuator and spring (not shown); or an inflatable air spring and pump (not shown). However, alternative compensating devices are contemplated that combine elements of these alternatives and all other suitable device known in the art. Compensating device 140 adjusts slowly, but with sufficient force to support the heaviest users (at least up to 200 kg). When a user steps on platform 194, the motion inducer 110 is forced to one extent of its travel. Compensating device 140 then engages and exerts a force on motion inducer 110 so that it compensates for the weight of the user on the platform. Hence, compensating device 140 only engages when the load on the platform changes, typically when someone gets on or off the platform.

Motion inducer 110 is a mechanical device that converts electrical signals from control electronics 193 to a physical action or rotational force via linkage 174, 178 and 172. In most preferred embodiments motion inducer 110 is a servo-controlled, moving magnet actuator; however, alternative motion inducers are contemplated, such as linear motors, pneumatic actuators, hydraulic actuators, and all other suitable motion inducers known in the art.

The amplitude and frequency of vibrations generated in platform 194 by motion inducer 110 are capable of being adjusted by control electronics 193. Thus, an operator of the device 100 can tune the frequency and amplitude of the vibrating platform 194 to achieve various outcomes, such as, speed and endurance training, promoting bone growth, therapeutically treating bone fractures, osteoporosis, other tissue conditions, postural instability, and other conditions such as cystic fibrosis, Parkinson's disease, arthritis, improved vascular circulation, treatment of the lymphatic system, and multiple sclerosis. In most preferred embodiments the minimum and maximum operating frequency of motion inducer 110 is 1 Hz and 100 Hz, respectively, inclusive of the endpoints. In addition, the maximum amplitude of vibration is no less than 25 mm.

User interface 191 is preferably a color LCD screen that provides a user with an intuitive interface having at least one of the following features: (a) biometric operator identification; (b) recent workout selection, such that the control electronics 193 recalls the most recent workout session for the current operator; (c) session history, such that control electronics 193 records a record of each session for each operator, as well as the operator's weight; (d) intelligent pause, such that, if the operator steps off the device during use, control electronics 193 pauses the current session and automatically resumes the current session when the operator steps back on the machine, and (e) an adjustment feature that allows the operator to modify treatment session parameters, for example time, vibration amplitude, frequency and waveform.

User interface 191 and control electronics 193 can include a method for altering the waveform of a vertical component of motion of the platform 194, other than merely the amplitude and frequency of the oscillatory force to achieve different treatment effects. As used herein, the term “treatment” should be interpreted broadly to include exercise. Preferred waveforms include a modified sinusoid wave, and a waveform that reflects constant acceleration, but as used herein, the term “waveform” should also be interpreted broadly as including patterns that are not particularly repetitive. It is contemplated that the waveforms can be updated or new waveforms added from an external memory storage device, such as a USB memory stick.

Vibration device 100 preferably includes a position sensor 162 that feeds the control electronics 193 which allows closed loop control to ensure that platform 194 follows the desired oscillatory pattern. In most preferred embodiments, the position sensing device is an absolute position sensor, but an incremental position sensor is contemplated. In most preferred embodiments, the position sensor consists of a linear arrangement of a plurality of magnetic field sensors that together with software algorithms measure the linear position of a magnet as it travels past the magnetic field sensors, but any other suitable position sensing device known in the art is contemplated.

Preferred linkage comprises deformable coupling 172 to the platform 194, reciprocating, pivoting rocker shafts 178, and deformable coupling 174 to the motion inducer 110. Reciprocating rocker shaft 178 converts the linear force generated by motion inducer 110 (via coupling 174) into a force that is applied to platform 194 (via couplings 172), whereby at least a first portion of the platform vibrates in a substantially vertical motion as shown by arrow 192. As used herein, the term “substantially vertical motion” should be interpreted broadly to mean that the vibrating motion includes at most a 20% non-vertical component. In most preferred embodiments, the force generated by motion inducer 110 is sufficient to induce a 0.2 g to 1 g acceleration on the platform when operated with a 100 kg weight. Advantageously, the reciprocating, pivoting rocker shaft 178 connects to the motion inducer, frame and vibrating platform with deformable couplings instead of sliding bearings in order to reduce backlash and rattle in the linkage system.

In an alternative embodiment, a second motion inducer (not shown) is contemplated that cooperates with the first motion inducer 110 to impart a substantially vertical motion to at least a second portion of the platform, such that the first portion of the platform moves substantially vertically independently of the second portion of the platform.

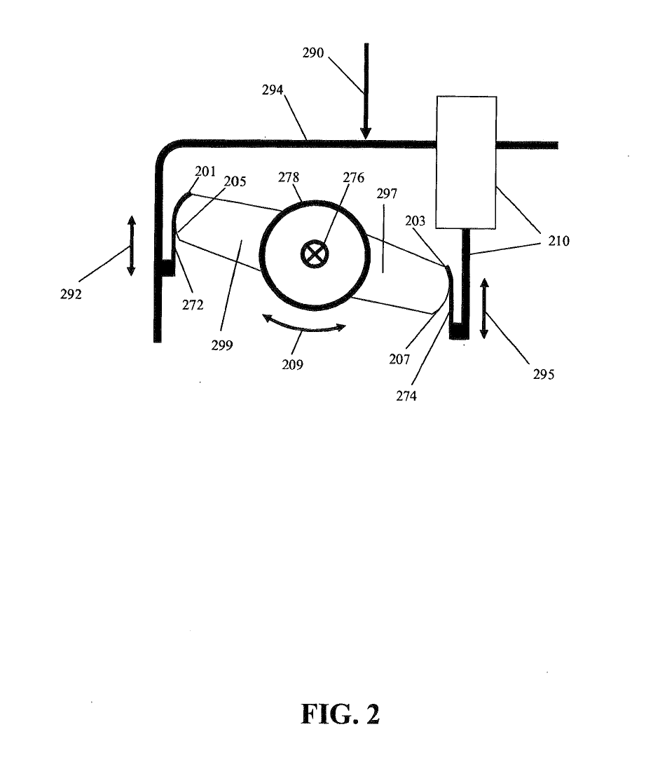

FIG. 2 is a cross sectional view (taken at right angles to the view of FIG. 1) in which like elements are given like numbering in the 200's instead of the 100's as in FIG. 1. FIG. 2 illustrates the mechanism that transfers movement from the motion inducer to at least one part of the vibrating platform and shows one half of the coupling mechanism extending to one side of the motion inducer 210 and one attachment point 272 to the vibrating platform 294, with load 290. The other half of the coupling mechanism is not illustrated, but it extends, in mirror image, to the other side of the motion inducer 210.

In most preferred embodiments there are four attachment points 272; one at each corner of the vibrating platform 294.

Rocker shaft 278 pivots about bearing 276 and each rocker shaft 278 has a set of rocker arms attached thereto at either end of the rocker shaft 278. At the motion inducer end of the rocker shaft 278, motion inducer 210 is attached to the top edge 203 of rocker arm 297 via a deformable coupling 274 and vibrating platform 294 is attached to the top edge 201 of opposite rocker arm 299 via deformable coupling 272. At the other end of rocker shaft 278 (not shown), vibrating platform 294 is attached to the top edge of a rocker arm similar to rocker arm 299 via a deformable coupling similar to deformable coupling 272.

Motion inducer 210 connects to one end of the deformable coupling 274. Deformable coupling 274 is attached at edge 203 of rocker arm 297. The reciprocating motion 295 of motion inducer 210 thus induces a rotationally reciprocating motion 209 of rocker shaft 278, with deformable coupling 274 wrapping and unwrapping about the rounded edge 207 of rocker arm 297. Similarly, the rotationally reciprocating motion 209 of rocker shaft 278 causes deformable coupling 272 to wrap and unwrap about the rounded edge 205 of rocker arm 299.

The linear reciprocating motion 295 of motion inducer 210 is thus converted to rotational reciprocation motion 209 of rocker shaft 278 which results in linear reciprocating motion 292 of vibrating platform 294.

Advantageously, bearing 276 is a maintenance free, backlash free, frictionless pivot bearing.

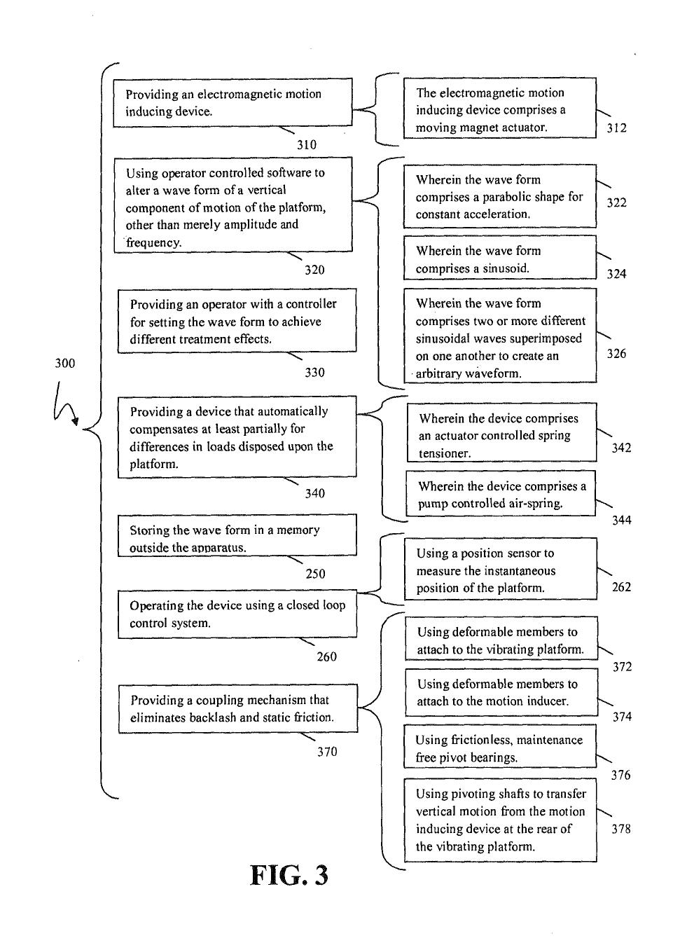

FIG. 3 is a block diagram illustrating the steps of a method 300 of driving a vibration device 100 that includes a vibrating platform 194, 294 in which like elements are given like numbering in the 300's instead of the 100's (FIG. 1) or the 200's (FIG. 2). Contemplated method 300 includes the steps of: (a) providing an electromagnetic motion inducing device 310, such that the electromagnetic motion inducing device comprises a moving magnetic actuator 312; (b) using operator controlled software to alter a waveform of a vertical component of motion of the platform, other than merely the amplitude and frequency 320, wherein the waveform comprises at least one of a repeating parabolic shape for constant acceleration 322, a sinusoidal wave 324, and a waveform comprising two or more different sinusoidal waves superimposed on one another to create an arbitrary waveform 326; (c) providing an operator with a controller for setting the waveform to achieve different treatment effects 330; (d) providing a device that automatically compensates at least partially for differences in loads disposed upon the platform 340, wherein the device comprises at least one of an actuator controlled spring tensioner 342, a pump controlled air-spring 344; (e) storing the waveform in a memory outside the apparatus 350; (f) operating the device using a closed loop control system 360, such that the control system utilizes a position sensor to measure an instantaneous position of the height of the platform 362; and (g) providing a coupling mechanism that eliminates backlash and static friction using at least one of; deformable couplings to attach to the vibrating platform 372, deformable couplings to attach to the motion inducer 374, frictionless, maintenance free pivot bearings 376, pivoting rocker shafts to transfer vertical motion from the motion inducing device at the rear of the vibrating platform 378.

Thus, specific embodiments and applications of a vibration apparatus with side or rear positioned actuator have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C and N, the text should be interpreted as requiring only one element from the group, not A plus N, or B plus N, etc.

What is claimed is:

1-31. (canceled)

32. A vibrating apparatus comprising:
a movable platform adapted to support a person;
a motion inducer positioned other than under the platform; and
at least one linkage adapted to transfer motion from the motion inducer to the platform such that the platform moves substantially vertically, wherein the motion inducer comprises a linear motor.

33. The vibrating apparatus according to claim 32, wherein each linkage includes at least one reciprocable, pivoting rod connected to the motion inducer and the platform by means of link arms extending radially from the rod and connected, by means of deformable couplings, to the motion inducer and platform respectively.

34. The vibrating apparatus according to claim 33, wherein the deformable couplings are each constituted by a strip of resiliently deformable material, one end of which is connected to the link arm and the other end of which is connected to the motion inducer or to the platform.

35. The vibrating apparatus according to claim 33, wherein each pivoting rod is mounted in a frame adapted to support the platform, each rod being mounted in the frame by means of frictionless, backlash-free, bearings.

36. The vibrating apparatus according to claim 32, comprising means adapted to compensate for differences in the load to be driven, in use, by the motion inducing device, constituted by the mass supported by the platform.

37. The vibrating apparatus according to claim 36, wherein the compensating means includes an adjustable air spring.

38. The vibrating apparatus according to claim 36, wherein the compensating means includes a coil spring and linear actuator.

39. The vibrating apparatus according to claim 36, wherein the compensating means is adapted to adjust the power applied to the motion inducer dynamically in dependence on the working load constituted by the mass to be vibrated by means of the platform.

40. The vibrating apparatus according to claim 32, comprising logic means that is programmable to control the waveform of a vertical component of motion of the platform other than the amplitude or frequency and a controller by means of which an operator may program the logic means to set the waveform in use.

41. The vibrating apparatus according to claim 32, comprising at least one sensor adapted to measure the instantaneous linear displacement of the platform, the programmable logic means being adapted to adjust the motion of the platform in accordance with the displacement of the platform, as measured by the sensor.

42. A method of operating the vibrating apparatus according to claim 32, comprising the steps of programming the electromagnetic motion inducing device with operator controllable programmable logic means to alter a waveform of a vertical component of motion of the platform other than merely amplitude and frequency and setting the waveform, in use, to achieve different treatment effects.

43. A method according to claim 41, comprising the specific step of programming the waveform to comprise a predetermined, repeating shape in use.

44. A method according to claim 41, comprising the specific step of programming the waveform to comprise a plurality of different sinusoidal waves superimposed on one another to create a randomly varying arbitrary waveform shape in use.
